(19) United States
(12) Patent Application Publication
(10) Pub. No.: US 2026/0180935 A1
(43) Pub. Date: Jun. 25, 2026

(54) METHOD, APPARATUS, DEVICE AND STORAGE MEDIUM FOR STICKER RESOURCE GENERATION

(71) Applicants: Lemon Inc., Grand Cayman (KY); Beijing Zitiao Network Technology Co., Ltd., Beijing (CN)

(72) Inventors: Lingshuang KONG, Culver City, CA (US); Lingxuan Shen, Beijing (CN); Zhenan Li, Beijing (CN); Weijian Chen, Beijing (CN)

(21) Appl. No.: 19/418,876

(22) Filed: Dec. 12, 2025

(30) Foreign Application Priority Data
Dec. 20, 2024 (WO) PCT/CN2024/141145

(51) Int. Cl. H04L 51/04; G06T 7/246; H04L 51/10

(52) U.S. Cl. CPC H04L 51/04; G06T 7/246; H04L 51/10

(57) ABSTRACT

According to embodiments of the disclosure, a method and an apparatus for sticker resource generation are provided. A method includes: presenting an image obtaining interface associated with an application; obtaining a reference image via the image obtaining interface; and providing a second sticker resource generated by the base reference image and a first sticker resource associated with the application. The second sticker resource includes a motion associated with a target object in the reference image, and the motion is determined based on the first sticker resource.

### CROSS-REFERENCE

The present application claims priority to PCT Application No. PCT/CN2024/141145, filed on Dec. 20, 2024, and entitled “METHOD, APPARATUS, DEVICE AND STORAGE MEDIUM FOR STICKER RESOURCE GENERATION”, the entirety of which is incorporated herein by reference.

### FIELD

Example embodiments of the present disclosure generally relate to the field of computers, and in particular, to a method, an apparatus, a device, and a computer-readable storage medium for sticker resource generation.

### BACKGROUND

Social applications, as symbolic products of the Internet era, change the communication and communication modes of people in daily life. In a traditional social approach, text is a major expression tool. However, with the development of the Internet, sticker resources (which may also be referred to as stickers or emoticons) gradually become an important way for people to express feelings and ideas.

### SUMMARY

In a first aspect of the present disclosure, a method for sticker resource generation is provided. The method includes: presenting an image obtaining interface associated with an application; obtaining a reference image via the image obtaining interface; and providing a second sticker resource generated based on the reference image and a first sticker resource associated with the application, the second sticker resource comprises a motion associated with a target object in the reference image, and the motion is determined based on the first sticker resource.

In a second aspect of the present disclosure, an apparatus for sticker resource generation is provided. The apparatus includes: a presentation module configured to present an image obtaining interface associated with an application; an obtaining module configured to obtain a reference image via the image obtaining interface; and a providing module configured to provide a second sticker resource generated based on the reference image and a first sticker resource associated with the application, wherein the second sticker resource includes a motion associated with a target object in the reference image, and the motion is determined based on the first sticker resource.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A to 2F illustrate example interfaces for sticker resource generation according to some embodiments of the present disclosure;

FIG. 3 shows a flowchart of an example process of sticker resource generation according to some embodiments of the present disclosure;

FIG. 4 illustrates a schematic structural block diagram of an example apparatus for sticker resource generation according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including/comprising” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and only within a specified or agreed range. The user rejection of processing of personal information other than necessary information required by the basic function will not affect usage of the basic function by the user.

As mentioned above, the social applications as symbolic products of the Internet era change the communication and communication manner of people in daily life. In a traditional social approach, text is a major sticker tool. However, with the development of the Internet, sticker resources (which may also be referred to as stickers or emoticons) gradually become an important way for people to express feelings and ideas.

Embodiments of the disclosure provide a solution for sticker resource generation. The solution comprises: presenting an image obtaining interface associated with an application; obtaining a reference image via the image obtaining interface; and providing a second sticker resource generated based on the reference image and a first sticker resource associated with the application, the second sticker resource comprises a motion associated with a target object in the reference image, and the motion is determined based on the first sticker resource.

In this way, the embodiments of the present disclosure can generate the second sticker resource based on the obtained reference image and the first sticker resource, thereby helping the user better obtain the desired information.

Various example implementations of this solution are described in detail below in conjunction with the accompanying drawings.

### Example Environment

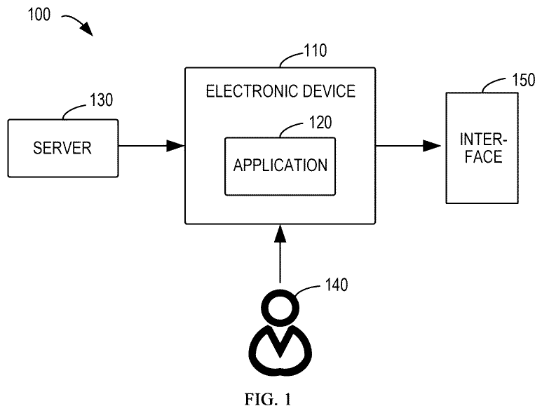

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports sticker resource generation. The application 120 may be any suitable type of application for sticker resource generation, examples of which may include, but are not limited to, social applications, content sharing applications, online video applications, or other suitable applications. A user 140 may interact with the application 120 via the electronic device 110 and/or its attachment device.

In the environment 100 of FIG. 1, if the application 120 is active, the electronic device 110 may present, via the application 120, an interface 150 for supporting sticker resource generation.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for an application 120 that supports generating sticker resources in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

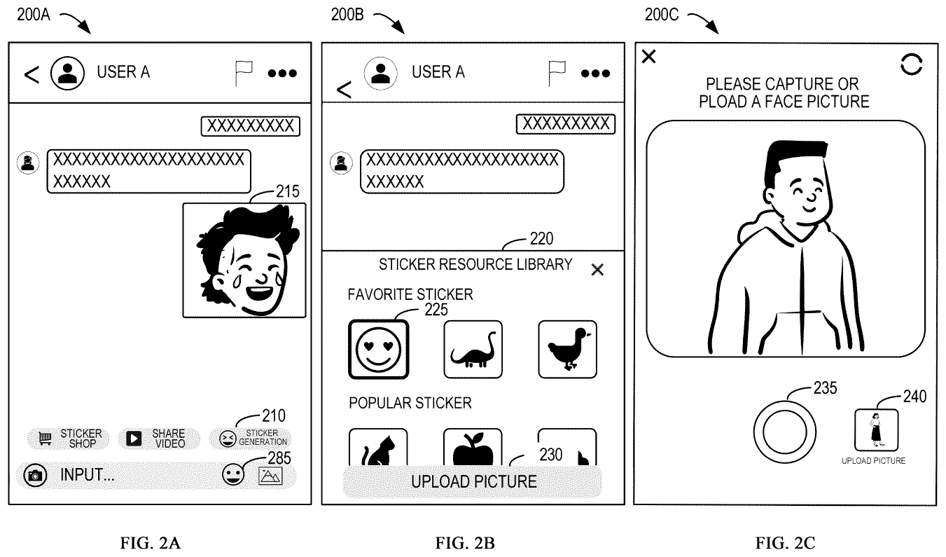

FIGS. 2A to 2F illustrate example interfaces 200A to 200F, in accordance with some embodiments of the present disclosure. The interface 200A to the interface 200F may be provided, for example, by the electronic device 110 shown in FIG. 1.

In some embodiments, the electronic device 110 may present the interface 200A as shown in FIG. 2A to the user 140. The interface 200A may be a messaging interface (i.e., a chat interface) between the user 140 and a friend of the user 140. The user 140 may send a text message or a media message to the friend through the interface 200A. Such a media message may be, for example, an image selected or captured by the user 140, or may be a sticker resource selected by the user 140 (which may also be referred to as an emoticon).

### Example 1

In some embodiments, after presenting the chat interface, the electronic device 110 may obtain the first emoticon (that is, the first sticker resource) selected by the user 140 to generate the second emoticon (that is, the second sticker resource). Specifically, the electronic device 110 may present a chat interface of an application, where the chat interface includes an interaction entry. Further, the electronic device 110 may present, in response to a selection of the interaction entry, a set of candidate sticker resources associated with the application.

As an example, as shown in FIG. 2A, the electronic device 110 may present a sticker generation entry 210 in the interface 200A. After the electronic device 110 receives the selection of the sticker generation entry 210 by the user 140, a sticker resource library 220 shown in FIG. 2B may be presented. The sticker resource library 220 includes a plurality of candidate emoticons (that is, candidate sticker resources), and such emoticons may be, for example, a set of emoticons favorited by the user 140, or may be a set of recommended emoticons. The recommended emoticon may be, for example, recommended by the server 130 to the user 140 based on the number of times the plurality of emoticons are used, or may be determined by the server 130 based on historical interaction information of the user 140.

In some embodiments, after presenting the sticker resource library 220, the electronic device 110 may determine the first emoticon by selecting any emoticon in the sticker resource library 220 by the user 140. Specifically, the electronic device 110 may present a set of candidate sticker resources associated with the application. Further, the electronic device 110 may receive a selection of a first sticker resource in a set of candidate sticker resources. As an example, after presenting the sticker resource library 220, the electronic device 110 may receive a selection of a first emoticon 225 in the sticker resource library 220 by the user 140 to determine the first emoticon 225 for generating the second emoticon. The first emoticon 225 may be a static image or a dynamic image (Graphics Interchange Format, GIF) with face information. For example, the first emoticon 225 may be a facial image of a person with “heart-like eyes”, and “heart-like eyes” may be cyclically zoomed in and out.

### Example 2

In some embodiments, the electronic device 110 may further determine the first emoticon based on the chat message in the chat interface. Specifically, the electronic device 110 may present, in the chat interface of the application, a chat message including the first sticker resource. Further, the electronic device 110 may determine the first sticker resource based on a predetermined operation on the chat message.

As an example, as shown in FIG. 2A, after the user 140 sends the chat message to the friend through the electronic device 110, the electronic device 110 may present the sent chat message 215 in the interface 200A. The chat message 215 may include, for example, a first emoticon. Further, after receiving the interaction operation performed by the user 140 on the chat message 215, the electronic device 110 may present a first extension bar. The first extension bar includes a first sticker generation control. The electronic device 110 may determine, in response to receiving the selection of the first sticker generation control in the extension bar by the user 140, that the chat message 215 is the first emoticon.

In this way, the user can more conveniently select the first sticker resource, thereby improving the generation process of the second sticker resource.

In some embodiments, when obtaining the first emoticon, the electronic device 110 may further determine whether the candidate emoticon selected by the user 140 includes an image portion of a second predetermined type. Specifically, the electronic device 110 may obtain a candidate sticker resource selected by the user. Further, the electronic and device 110 may determine the candidate sticker resource as the first sticker resource in response to the candidate sticker including a reference object of the second predetermined type. As an example, the second predetermined type may be, for example, a facial expression of a person. After receiving the candidate emoticon, the electronic device 110 may determine whether a facial expression of a person is present in the candidate emoticon. If the facial expression of the person is present, the electronic device 110 may use the candidate emoticon as the first emoticon. For example, the candidate emoticon is a “hear-like eyes” emoticon, and the electronic device 110 may determine that there is an image region corresponding to the facial expression in the “hear-like eyes” emoticon, that is, the eye part replaced with the hear-like eyes. The process of determining whether the candidate emoticon includes the image portion of the second predetermined type may be performed by the electronic device 110, or may be performed by the server 130.

After the first emoticon is determined, the electronic device 110 may obtain the reference image to obtain the second emoticon generated based on the first emoticon and the reference image. The following describes an interaction process of the electronic device 110 providing the second emoticon to the user 140.

In some embodiments, the electronic device 110 presents an image obtaining interface associated with the application. As an example, as shown in FIG. 2B, after receiving the selection of the first emoticon 225 by the user 140, the electronic device 110 may display the first emoticon 225 in a highlighted style. Such a highlighted style may be, for example, adding a bolded border of the first emoticon 225, using a distinguished color to present the first emoticon 225, and the like. Further, the electronic device 110 may present the interface 200C as shown in FIG. 2C in response to a picture upload control 230 being selected. The interface 200C may be the obtaining interface of the reference image, and the obtaining interface of the reference image may be, for example, an image capturing interface.

In some embodiments, after the image obtaining interface is presented, the electronic device 110 may obtain the reference image via the image obtaining interface. As an example, as shown in FIG. 2C, the electronic device 110 may obtain an image captured by the user 140 through the interface 200C to use the image as a reference image for generating the second emoticon. In some scenarios, the electronic device 110 may also present an album based on the selection of an album entry 240 by the user 140. Further, after a target image in the album is selected by the user 140, the electronic device 110 may obtain the target image as the reference image for generating the second emoticon.

Additionally or alternatively, as shown in FIG. 2A, the electronic device 110 may present the interface 200A. The interface 200A may be a chat interface between user 140 and a friend. The interface 200A includes a plurality of chat messages, such as chat message 215. The chat message 215 may include, for example, an image sent by the user 140 to the friend via the electronic device 110. Such a picture may be an image captured by the user 140 through the capturing interface, or may be an image selected by the user 140 in the album. The electronic device 110 may receive a long-press operation of the chat message 215 by the user 140, and present a second extension bar. The second extension bar includes at least a second sticker generation control. After receiving the selection of the second sticker generation control by the user 140, the electronic device 110 may determine that the image in the chat message 215 is the reference image used to generate the second emoticon.

In some embodiments, when the reference image is obtained, the electronic device 110 further needs to determine that the reference image is associated with the first predetermined type. Specifically, the electronic device 110 may obtain the captured first image or the uploaded second image via the image obtaining interface. Further, the electronic device 110 may determine the first image or the second image as the reference image in response to the first image or the second image including the target object of the first predetermined type.

As an example, as shown in FIG. 2C, after the capturing control 235 is clicked by the user 140, the electronic device 110 may obtain the first image captured by the user 140. The electronic device 110 may also obtain a second image selected by the user 140 via the album entry 240. Further, when the first image or the second image includes the image portion corresponding to the target object of the first predetermined type, the electronic device 110 may use the first image or the second image as the reference image. The image portion corresponding to the first predetermined type may be, for example, a facial image of a person. For example, if the first image is a front photo including a person's face, and the second image is a back photo of the person, the electronic device 110 may determine that the first image is the reference image used to generate the second emoticon.

In some embodiments, after the first emoticon and the reference image are determined, the electronic device 110 may send the first emoticon and the reference image to the server 130, so that the server 130 generates the second emoticon. Specifically, the server 130 may determine first motion information associated with a first set of feature points from the first sticker resource. A set of feature points is associated with a reference object in the first sticker resource. As an example, the first emoticon may be, for example, an “heart-like eyes” emoticon, and the server 130 may determine that the facial expression (that is, the eye of the heart shape) in the emoticon is the first set of feature points. Further, the server 130 may determine the first motion information of the eye of the heart shape (e.g., the eye becomes the heart and zooms in and out cyclically).

Further, the server 130 may determine, based on the first motion information, second motion information associated with a second set of feature points in the reference image, and the second set of feature points is associated with the target object. As an example, the server 130 may determine a second set of feature points in the reference image corresponding to the first set of feature points. For example, if the first set of feature points is the eye part in the first emoticon, the second set of feature points may be eyes of a person in the reference image. After determining the second set of feature points, the server 130 may determine the second motion information based on the first motion information. The second motion information may be a motion trajectory of an eye of a person in the reference image.

Finally, the server 130 may generate the second sticker resource based on the second motion information. As an example, the second motion information may be, for example, an eye changing into a heart, and cyclically zooming in and out. The server 130 may add the animation effect (that is, the second motion information) to the reference image, so that the eyes of the person in the reference image changes into a heart and cyclically zoom in and out.

In some embodiments, after the second emoticon is generated, the electronic device 110 may present a reminder for completion of the generation. Specifically, the electronic device 110 may present, in the application, a reminder related to completion of the generation of the second sticker resource. As an example, as shown in FIG. 2D, when the second emoticon is generated, the electronic device 110 may present a prompt message 245 in the interface 200D. The prompt message 245 is used to remind that the second emoticon has been generated, and the prompt message 245 includes a preview control 250. In this way, the user can be timely reminded that the generation of emoticon is completed, thereby improving the interaction experience between the user and the application.

Further, the electronic device 110 may present a viewing interface in response to triggering of the reminder. The viewing interface displays the second sticker resource. As an example, as shown in FIG. 2D, after receiving the selection of the preview control 250 by the user 140, the electronic device 110 may present the interface 200E shown in FIG. 2E. The interface 200E may be, for example, a preview interface (that is, the viewing interface) of the second emoticon, and the second emoticon 255 that is generated is displayed in the interface 200E.

In some embodiments, the electronic device 110 may add the second emoticon to the favorites based on a second operation performed by the user on the second emoticon. Specifically, the electronic device 110 may add the second sticker resource to the sticker resource set in the application in response to the second operation on the second sticker resource. As an example, as shown in FIG. 2E, after receiving the selection of a favorites control 260 by the user 140, the electronic device 110 may add the second emoticon to the favorites folder. The favorites folder may be, for example, a collection of multiple sticker resources. After the second emoticon is added to the favorites folder, the electronic device 110 may present the second emoticon 255 in the emoticon favorites 280 as in FIG. 2F.

In some embodiments, the electronic device 110 may further receive configuration information of the user 140 on the second emoticon in the interface 200E, and adjust the second emoticon based on the configuration information. Specifically, the electronic device 110 may set a public scope of the second sticker resource in response to a third operation on the second sticker resource. As an example, as shown in FIG. 2E, the interface 200E further includes a public control 265. The user 140 may switch the public state of the second emoticon via the public control 265. When the public control 265 is in the activated state, the second emoticon may be presented publicly in the predetermined range. The predetermined range may be, for example, visible to everyone, or may be a public scope (for example, only visible to friends) set manually by the user 140. When the second emoticon is in a visible state to everyone, the second emoticon may be added to a predetermined sticker shop, so that other users can see and use the second emoticon in the sticker shop.

In some scenarios, when the public control 265 is selected by the user 140, that is, the public control 265 is not in the activated state, the second emoticon can only be seen and used by the user 140.

In this way, the user can more conveniently select the visible state of the second emoticon, thereby improving the configuration efficiency of the second emoticon.

In some embodiments, the electronic device 110 may receive a first keyword associated with the second sticker resource. Further, the electronic device 110 may associate the first keyword to the second sticker resource, so that the second sticker resource can be obtained based on the first keyword. The second sticker resource is further associated with a second keyword determined based on the first sticker resource and/or the reference image.

As an example, as shown in FIG. 2E, the interface 200E further includes a keyword input component 270. The user 140 may associate the second emoticon with the input first keyword via the keyword input component 270. In some scenarios, the electronic device 110 may further present a predetermined keyword in the keyword input component 270, where the predetermined keyword may be generated by the server 130 based on the second emoticon. The first keyword may be, for example, “passionate love”.

Additionally or alternatively, the second emoticon is further associated with the second keyword, and the second keyword is determined according to the first emoticon for generating the second emoticon. For example, if the first emoticon is a “heart-like eyes” emoticon, the second keyword may be “heart-like eyes”.

After the first keyword and the second keyword are associated with the second emoticon, the second emoticon may be obtained based on the first keyword and the second keyword. As an example, the electronic device 110 may present a sticker shop, and the sticker shop includes a plurality of public emoticons and a search component. The electronic device 110 may obtain, via the search component, a second keyword (i.e., “heart-like eyes”) inputted by the user 140 to obtain the second emoticon based on “heart-like eyes”.

In this way, the second emoticon can be more quickly and conveniently obtained and used by other users, thereby improving the efficiency of information obtaining.

In some embodiments, the electronic device 110 may present an indication element associated with sending of the second sticker resource, and the indication element represents that the second sticker resource is generated based on the reference image and the first sticker resource. As an example, as shown in FIG. 2E, the electronic device 110 may present the indication element 275 in the interface 200E to remind the user 140 through the indication element 275 that the second emoticon 255 is generated based on the reference image and the first emoticon.

In some embodiments, after the second emoticon is generated and configured, the electronic device 110 may provide the second emoticon to the user 140. Specifically, the electronic device 110 may provide the second sticker resource generated based on the reference image and the first sticker resource. The first sticker resource is associated with an application. The second sticker resource includes a motion associated with the target object in the reference image, and the motion is determined based on the first sticker resource.

As an example, as shown in FIG. 2A to FIG. 2F, the electronic device 110 may receive a selection of a sticker control 285 by the user 140, and present the emoticon favorites folder 280 shown in FIG. 2F. The electronic device 110 may present the generated second emoticon 255 in the emoticon favorites folder 280 to provide the second emoticon 255 to the user 140.

In some embodiments, the second emoticon 255 may be used by the user 140. Specifically, the electronic device 110 may send the second sticker resource in the application in response to the first operation on the second sticker resource. As an example, as shown in FIG. 2F, the electronic device 110 may receive a selection of the second emoticon 255 in the emoticon favorites folder 280 by the user 140. Further, the electronic device 110 may send the second emoticon 255 to a friend of the user 140 to present the second emoticon in the chat interface.

In this way, the embodiments of the present disclosure can generate the second sticker resource based on the obtained reference image and the first emoticon resource, thereby helping the user better obtain the desired information.

### Example Processes

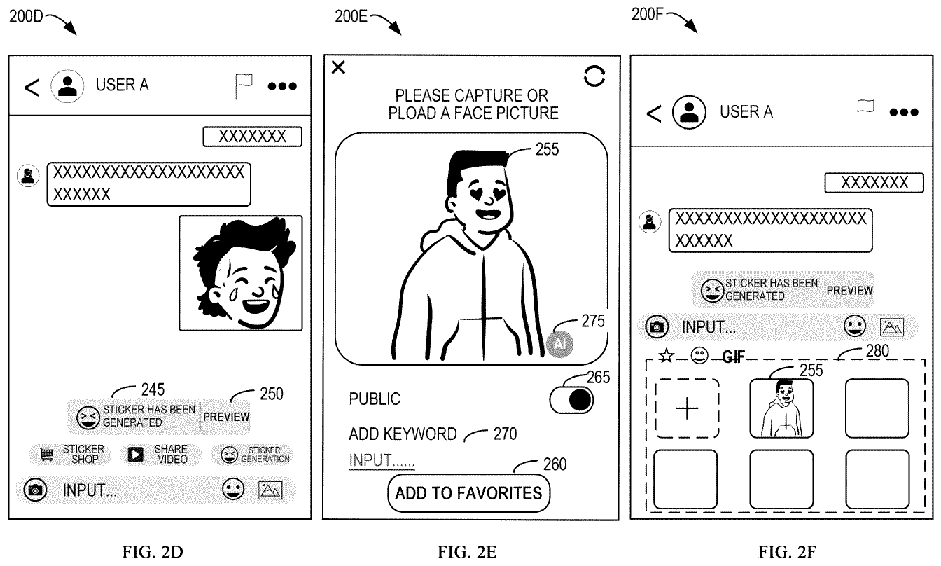

FIG. 3 shows a flowchart of an example process 300 for sticker resource generation according to some embodiments of the present disclosure. The process 300 may be implemented at electronic device 110. The process 300 is described below with reference to FIG. 1.

As shown in FIG. 3, at block 310, the electronic device 110 presents an image obtaining interface associated with an application.

At block 320, the electronic device 110 obtains a reference image via the image obtaining interface.

At block 330, the electronic device 110 provides a second sticker resource generated based on the reference image and a first sticker resource, the first sticker resource associated with the application, wherein the second sticker resource includes a motion associated with a target object in the reference image, the motion determined based on the first sticker resource.

In some embodiments, the process 300 further includes: presenting a set of candidate sticker resources associated with the application; and receiving a selection of the first sticker resource of the set of candidate sticker resources.

In some embodiments, presenting the set of candidate sticker resources associated with the application includes: presenting a set of candidate sticker resources associated with the application; and receiving a selection of the first sticker resource of the set of candidate sticker resources.

In some embodiments, the process 300 further includes: presenting, in a chat interface of the application, a chat message comprising the first sticker resource; and determining the first sticker resource based on a predetermined operation on the chat message.

In some embodiments, providing the second sticker resource generated based on the reference image and the first sticker resource includes: presenting, in the application, a reminder related to completion of generating the second sticker resource; and presenting, in response to triggering of the reminder, a viewing interface displaying the second sticker resource.

In some embodiments, the process 300 further includes: sending the second sticker resource in the application in response to a first operation on the second sticker resource.

In some embodiments, the process 300 further includes: presenting an indication element associated with the sent second sticker resource, the indication element representing that the second sticker resource is generated based on the reference image and the first sticker resource.

In some embodiments, the process 300 further includes: adding the second sticker resource to a sticker resource set in the application in response to a second operation on the second sticker resource.

In some embodiments, the process 300 further includes: setting a public scope of the second sticker resource in response to a third operation on the second sticker resource, such that the second sticker resource is available to a user in the public scope.

In some embodiments, the process 300 further includes: receiving a first keyword associated with the second sticker resource; and associating the first keyword to the second sticker resource, to enable the second sticker resource to be obtained based on the first keyword.

In some embodiments, the second sticker resource is further associated to a second keyword, and the second keyword is determined based on at least one of the first sticker resource or the reference image.

In some embodiments, the obtaining the reference image via the image obtaining interface comprises: obtaining, via the image obtaining interface, a first image that is captured or a second image that is uploaded; and determining, in response to the first image or the second image comprising the target object of a first predetermined type, the first image or the second image as the reference image.

In some embodiments, the process 300 further includes: obtaining a candidate sticker resource selected by a user; and determining, in response to the candidate sticker resource comprising a reference object of a second predetermined type, the candidate sticker resource as the first sticker resource.

In some embodiments, the second sticker resource is generated through: determining, from the first sticker resource, first motion information associated with a first set of feature points, the first set of feature points being associated with a reference object in the first sticker resource; determining, based on the first motion information, second motion information associated with a second set of feature points in the reference image, the second set of feature points being associated with the target object; and generating the second sticker resource based on the second motion information.

### Example Device and Apparatus

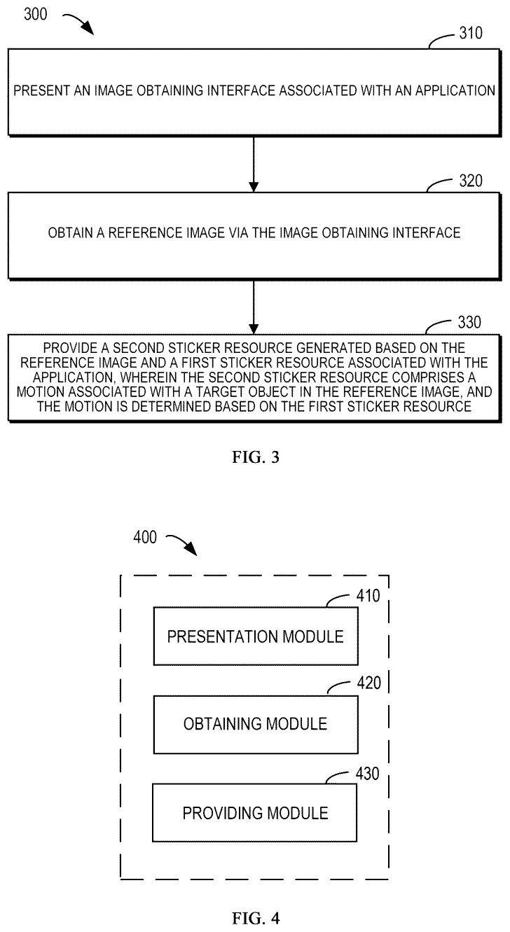

Embodiments of the present disclosure also provide a corresponding apparatus for implementing the above method or process. FIG. 4 illustrates a schematic structural block diagram of an example apparatus 400 for sticker resource generation according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: a presentation module 410 configured to present an image obtaining interface associated with an application; an obtaining module 420 configured to obtain a reference image via an image obtaining interface; and a providing module 430 configured to provide a second sticker resource generated based on the reference image and the first sticker resource, the first sticker resource being associated with the application, wherein the second sticker resource includes a motion associated with a target object in the reference image, the motion being determined based on the first sticker resource.

In some embodiments, the apparatus 400 further includes a resource presentation module configured to present a set of candidate sticker resources associated with the application; and receive a selection of the first sticker resource of the set of candidate sticker resources.

In some embodiments, the resource presentation module is further configured to: present a chat interface of the application, the chat interface comprising an interaction entry; and present, in response to a selection of the interaction entry, the set of candidate sticker resources associated with the application.

In some embodiments, the apparatus 400 further includes a message presentation module configured to present, in a chat interface of the application, a chat message comprising the first sticker resource; and determine the first sticker resource based on a predetermined operation on the chat message.

In some embodiments, the providing module 430 is further configured to: present, in the application, a reminder related to completion of generating the second sticker resource; and present, in response to triggering of the reminder, a viewing interface displaying the second sticker resource.

In some embodiments, the apparatus 400 further includes a sending module configured to send the second sticker resource in the application in response to a first operation on the second sticker resource.

In some embodiments, the apparatus 400 further includes an element presentation module configured to present an indication element associated with the sent second sticker resource, the indication element representing that the second sticker resource is generated based on the reference image and the first sticker resource.

In some embodiments, the apparatus 400 further includes an adding module configured to add the second sticker resource to a sticker resource set in the application in response to a second operation on the second sticker resource.

In some embodiments, the apparatus 400 further includes a setting module configured to set a public scope of the second sticker resource in response to a third operation on the second sticker resource, such that the second sticker resource is available to a user in the public scope.

In some embodiments, the apparatus 400 further includes an association module configured to receive a first keyword associated with the second sticker resource; and associate the first keyword to the second sticker resource, to enable the second sticker resource to be obtained based on the first keyword.

In some embodiments, the second sticker resource is further associated to a second keyword, and the second keyword is determined based on at least one of the first sticker resource or the reference image.

In some embodiments, the obtaining module 420 is further configured to obtain, via the image obtaining interface, a first image that is captured or a second image that is uploaded; and determine in response to the first image or the second image comprising the target object of a first predetermined type, the first image or the second image as the reference image.

In some embodiments, the apparatus 400 further includes a determining module configured to obtain a candidate sticker resource selected by a user; and determine, in response to the candidate sticker resource comprising a reference object of a second predetermined type, the candidate sticker resource as the first sticker resource.

In some embodiments, the second sticker resource is generated through: determining, from the first sticker resource, first motion information associated with a first set of feature points, the first set of feature points being associated with a reference object in the first sticker resource; determining, based on the first motion information, second motion information associated with a second set of feature points in the reference image, the second set of feature points being associated with the target object; and generating the second sticker resource based on the second motion information.

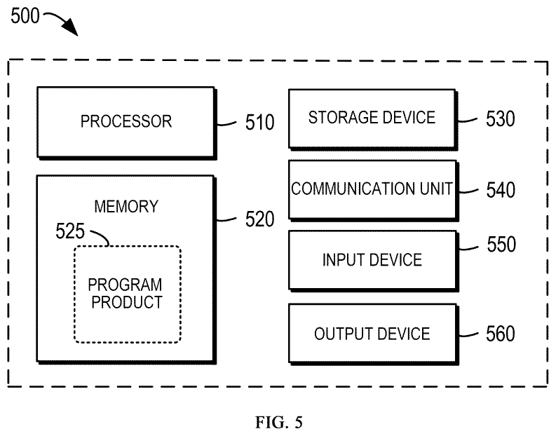

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for sticker resource generation, comprising:
presenting an image obtaining interface associated with an application;
obtaining a reference image via the image obtaining interface; and
providing a second sticker resource generated based on the reference image and a first sticker resource associated with the application, wherein the second sticker resource comprises a motion associated with a target object in the reference image, and the motion is determined based on the first sticker resource.

2. The method of claim 1, further comprising:
presenting a set of candidate sticker resources associated with the application; and
receiving a selection of the first sticker resource of the set of candidate sticker resources.

3. The method of claim 2, wherein presenting the set of candidate sticker resources associated with the application comprises:
presenting a chat interface of the application, the chat interface comprising an interaction entry; and
presenting, in response to a selection of the interaction entry, the set of candidate sticker resources associated with the application.

4. The method of claim 1, further comprising:
presenting, in a chat interface of the application, a chat message comprising the first sticker resource; and
determining the first sticker resource based on a predetermined operation on the chat message.

5. The method of claim 1, wherein providing the second sticker resource generated based on the reference image and the first sticker resource comprises:
presenting, in the application, a reminder related to completion of generating the second sticker resource; and
presenting, in response to triggering of the reminder, a viewing interface displaying the second sticker resource.

6. The method of claim 1, further comprising:
sending the second sticker resource in the application in response to a first operation on the second sticker resource.

7. The method of claim 6, further comprising:
presenting an indication element associated with the sent second sticker resource, the indication element representing that the second sticker resource is generated based on the reference image and the first sticker resource.

8. The method of claim 1, further comprising:
adding the second sticker resource to an sticker resource set in the application in response to a second operation on the second sticker resource.

9. The method of claim 1, further comprising:
setting a public scope of the second sticker resource in response to a third operation on the second sticker resource, such that the second sticker resource is available to a user in the public scope.

10. The method of claim 1, further comprising:
receiving a first keyword associated with the second sticker resource; and
associating the first keyword to the second sticker resource, to enable the second sticker resource to be obtained based on the first keyword.

11. The method of claim 1, wherein the second sticker resource is further associated to a second keyword, and the second keyword is determined based on at least one of the first sticker resource or the reference image.

12. The method of claim 1, wherein obtaining the reference image via the image obtaining interface comprises:
obtaining, via the image obtaining interface, a first image that is captured or a second image that is uploaded; and
determining, in response to the first image or the second image comprising the target object of a first predetermined type, the first image or the second image as the reference image.

13. The method of claim 1, further comprising:
obtaining a candidate sticker resource selected by a user; and
determining, in response to the candidate sticker resource comprising a reference object of a second predetermined type, the candidate sticker resource as the first sticker resource.

14. The method of claim 1, wherein the second sticker resource is generated through:
determining, from the first sticker resource, first motion information associated with a first set of feature points, the first set of feature points being associated with a reference object in the first sticker resource;
determining, based on the first motion information, second motion information associated with a second set of feature points in the reference image, the second set of feature points being associated with the target object; and
generating the second sticker resource based on the second motion information.

15. An electronic device comprising:
at least one processor; and
at least one memory coupled to the at least one processor and storing instructions for execution by the at least one processor, the instructions, when executed by the at least one processor, causing the electronic device to perform operations comprising:
presenting an image obtaining interface associated with an application;
obtaining a reference image via the image obtaining interface; and
providing a second sticker resource generated based on the reference image and a first sticker resource associated with the application, wherein the second sticker resource comprises a motion associated with a target object in the reference image, and the motion is determined based on the first sticker resource.

16. The electronic device of claim 15, the opereations further comprising:
presenting a set of candidate sticker resources associated with the application; and
receiving a selection of the first sticker resource of the set of candidate sticker resources.

17. The electronic device of claim 16, wherein presenting the set of candidate sticker resources associated with the application comprises:
presenting a chat interface of the application, the chat interface comprising an interaction entry; and
presenting, in response to a selection of the interaction entry, the set of candidate sticker resources associated with the application.

18. The electronic device of claim 15, the opereations further comprising:
presenting, in a chat interface of the application, a chat message comprising the first sticker resource; and
determining the first sticker resource based on a predetermined operation on the chat message.

19. The electronic device of claim 15, wherein providing the second sticker resource generated based on the reference image and the first sticker resource comprises:
presenting, in the application, a reminder related to completion of generating the second sticker resource; and
presenting, in response to triggering of the reminder, a viewing interface displaying the second sticker resource.

20. A non-transitory computer-readable storage medium having a computer program stored thereon, the computer program executable by a processor to implement operations comprising:
presenting an image obtaining interface associated with an application;
obtaining a reference image via the image obtaining interface; and
providing a second sticker resource generated based on the reference image and a first sticker resource associated with the application, wherein the second sticker resource comprises a motion associated with a target object in the reference image, and the motion is determined based on the first sticker resource.
